(19) United States
(12) Patent Application Publication
(10) Pub. No.: US 2009/0271742 A1
(43) Pub. Date: Oct. 29, 2009

(54) USER INTERFACE NAVIGATION DESIGN SYSTEM

(76) Inventors: Rui Zhang, Beijing (CN); John R. Hajdukiewicz, Florham Park, NJ (US); Shi Qiang Wang, Beijing (CN); Daoping Zhang, Beijing (CN); Harlin Liao, Beijing (CN)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/111,853

(22) Filed: Apr. 29, 2008

(51) Int. Cl. G06F 3/048

(52) U.S. Cl. 715/854

(57) ABSTRACT

A user interface navigation design system and method is described in this document. In some embodiments, a user interface (UI) navigation diagram is generated. The UI navigation diagram displays two or more of the plurality of screen views and corresponding navigation relationships. A screen view is selected according to a user interaction with the UI navigation diagram. A dynamic view of the user interface navigation diagram is provided as a function of the selected screen view. The dynamic view of the UI navigation diagram displays one or more navigation relationships associated with the selected screen view. The one or more navigation relationships include non-hyperlinked navigation relationships associated with the selected screen view.

### TECHNICAL FIELD

Embodiments of the present invention relate to user interfaces, and more particularly, but not by way of limitation, to user interface navigation systems.

### BACKGROUND

User interface design systems provide ways for user interface designers to develop interfaces. Under some interface design systems, graphical editing tools are provided. These graphical editing tools are used to express and control various components inside a user interface screen view, such as a page or form. Traditional user interface design systems, however, provide very limited ways to define views and visualize navigation relationships among the views.

For example, some existing user interface design systems, such as DreamWeaver, NetBeans, etc., only provide capabilities to define and visualize hyperlink-based navigation relationships among pages. Some other important navigation relationships are not addressed in these existing user interface design systems. In such cases, all the relationships may be hiding inside related pages. That is, the relationships are not based on a hyperlink but based on detailed configurations of the user interface components, such as a widget. Therefore, the existing user interface design systems do not serve well a large system where its user interface includes very complex relationships among pages. In addition, under the existing user interface design systems, it is hard to modify or maintain the user interface designs for such a large system, causing low productivity for developing a user interface.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1-A is an illustration of a “view host” in accordance with some embodiments.

FIG. 1-B is an illustration of a “view host” in accordance with some embodiments.

FIG. 2 is a schematic illustration of a generic navigation relationship in accordance with some embodiments.

FIGS. 3-A through 3-D are schematic illustrations of three special types of navigation relationships in accordance with some embodiments.

FIG. 4 is a schematic illustration of a navigation diagram in accordance with some embodiments.

FIG. 5 is a schematic illustration of several examples of representation of a page in accordance with some embodiments.

FIGS. 6-A and 6-B are schematic illustrations of an expanded view and collapsed view in accordance with some embodiments.

FIG. 7 is a schematic illustration of an environment for a graphical user interface (GUI) designing system in accordance with some embodiments.

FIG. 8 is a schematic illustration of a user interface navigation engine in accordance with some embodiments.

FIG. 9 is a flow chart of a method for designing a graphical user interface (GUI) in accordance with some embodiments.

FIGS. 10-12 are flow charts of detailed methods for designing a graphical user interface (GUI) in accordance with some embodiments.

### DESCRIPTION OF EXAMPLE EMBODIMENTS

A system and method for designing a navigation structure for a graphical user interface (GUI) is described in this document. The GUI has a plurality of screen views and navigation relationships among the screen views. Embodiments herein are a user interface design system that enables defining and navigating more comprehensive relationships among screen views. User interface design system embodiments also reduces cost and effort for modifying and maintaining a user interface design.

In some embodiments, a user interface (UI) navigation diagram is generated. The UI navigation diagram displays two or more of the plurality of screen views and corresponding navigation relationships. Then, a screen view is selected according to a user interaction with the UI navigation diagram. Once a screen view is selected, a dynamic view of the user interface navigation diagram is provided as a function of the selected screen view. The dynamic view of the UI navigation diagram displays one or more navigation relationships associated with the selected screen view. The one or more navigation relationships include not only hyperlinked navigation relationships but also non-hyperlinked navigation relationships associated with the selected screen view. The non-hyperlinked navigation relationships include, for example, widget navigation relationships.

A “view” or screen view is the basic unit of user interface navigation. A view could be shown/hidden according to the navigation semantic. A “page” is a kind of a “view.” The description of a “page” could be serialized in a user interface description file. For example, web page, window and dialog box are instances of a page and different types of a user interface page. A “template” is a parameterized page. It mainly exists for reusability. An “instance page” is the instance of a certain template.

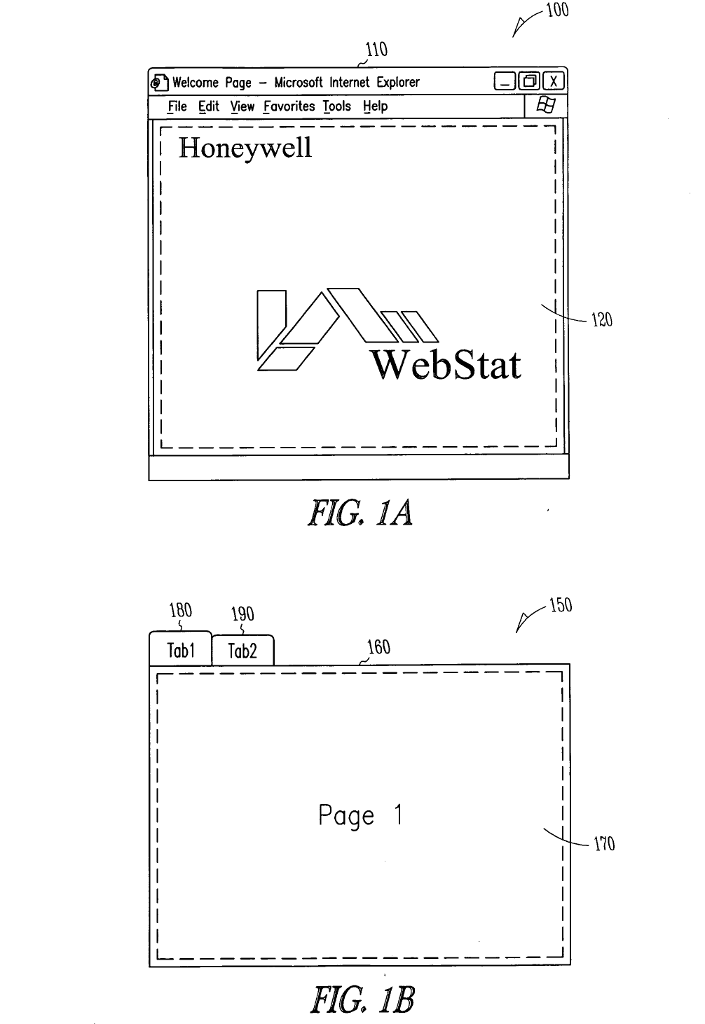

FIGS. 1-A and 1-B illustrate two examples 100, 150 of a “view host,” which is an object that can host a view, such as a page. As illustrated in FIG. 1-A, a web browser 110 is one example of a view host object and can host a web page 120. As illustrated in FIG. 1-B, a “view host widget” (hereinafter interchangeably “widget”) 160 is another example of a view host object and can host a graphical user interface page (Page 1) 170. In some embodiments, the view host widget 160 contains tab navigators 180, 190 to trigger the Page 1.

In some embodiments of the present invention, several relationships between pages exist. One of such relationship is an “instantiation relationship”. This relationship is generated between a template page and its instance pages. Another type of the relationship is a “navigation relationship” among views, such as pages. A navigation relationship shows a calling screen view, called screen view and screen view hosting the called screen view. In some embodiments, a tuple of three elements, <trigger, target view, target view host>, represents a navigation relationship. The “trigger” is a widget with which end users interact to trigger the navigation. The “target view” is the navigation's target to be viewed. The “target view host” is the navigation's destination host of the target view.

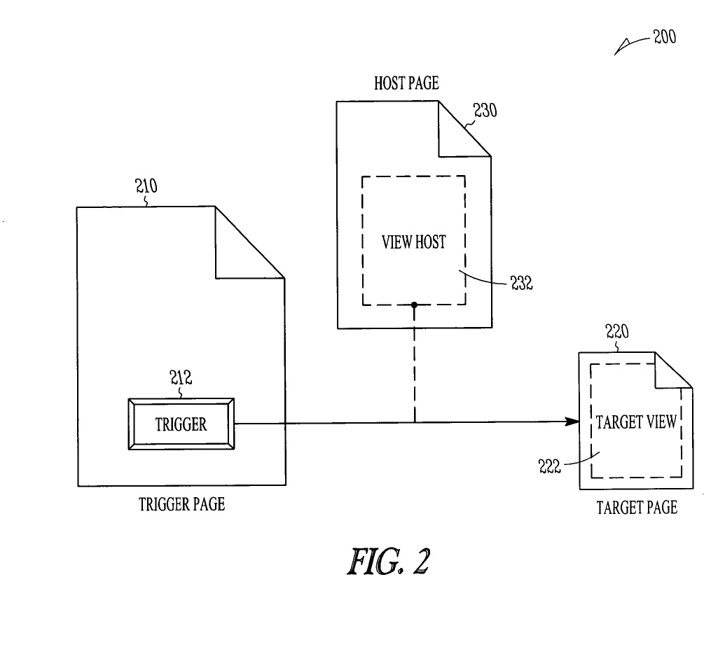

In some embodiments, a tuple of four elements, <navigation widget, navigation event, target view, target view host>, represents a navigation relationship. In most situations, the “navigation event” is a function provided by the “navigation widget.” For example, in some embodiments the “navigation widget” is a button, and the navigation event is a “click” on the button. Comparing this four element model with the three element model described above, it can be seen that the “navigation widget” and the “navigation event” of the four element model are merged into the “trigger” of the three element model. More detailed explanation of a navigation relationship is given below using FIGS. 2-6.

FIG. 2 illustrates a generic navigation relationship 200 provided by some embodiments of the present invention. The generic navigation relationship 200 involves three pages: a trigger page 210, target page 220 and host page 230. The trigger page 210 contains a trigger widget 212. The target page 220 contains a target view 222. The host page 230 contains the view of a target view host 232. In such a scenario, once the “trigger” 212 is triggered, for example, by a user, the system under the present invention places the target view 222 into the target view host 232. In some embodiments, the target view 222 is a template page.

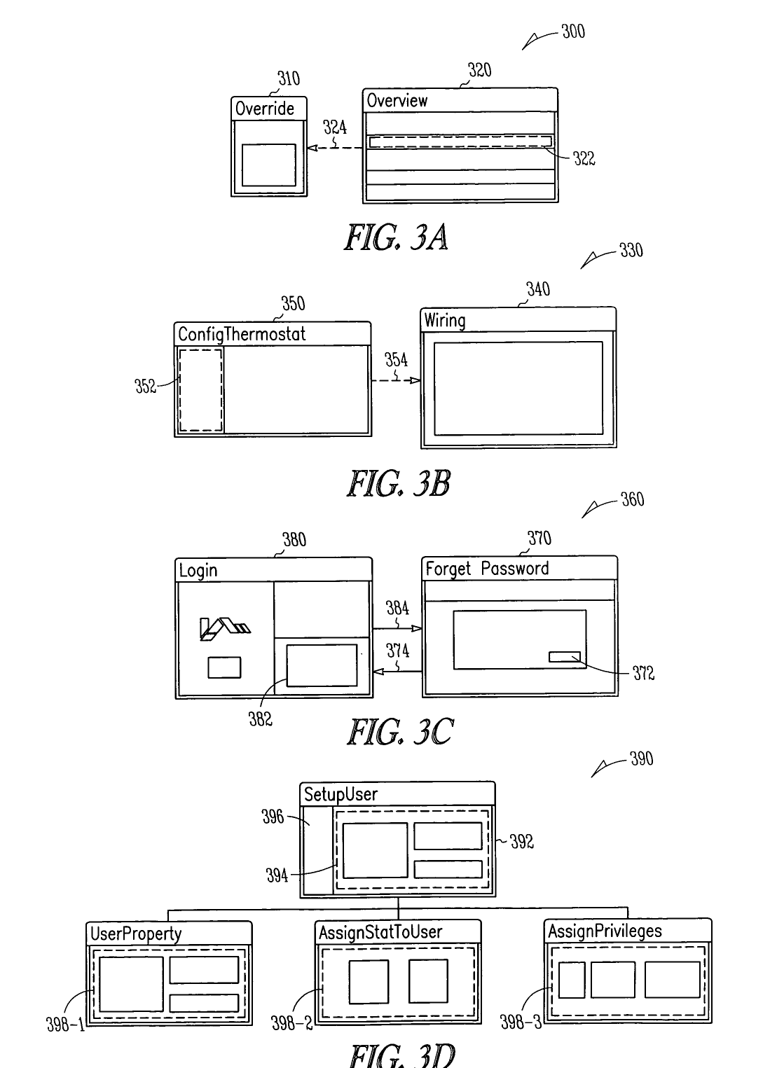

FIGS. 3-A through 3-D illustrate three special types of navigation relationships provided by some embodiments of the present invention: a “popup” navigation relationship, “link” navigation relationship and “host” navigation relationship. There are two kinds of the popup relationship: modal popup and modeless popup.

FIG. 3-A illustrates a modal popup navigation relationship 300 that involves an original view (e.g., “Overview” page) 320 and a popup target view (e.g., “Override” page) 310. The original view (e.g., “Overview” page) 320 contains a trigger 322 for the “Override” page. Once the trigger 322 is triggered, the “Override” page 310 is created and the “Overview” page 320 will be disabled for further interaction until the “Override” page 310 is closed. Such a modal popup navigation relationship is represented using, for example, a dotted line with a dark triangle at one end thereof 324. The leftward orientation of the triangle indicates that the “Overview” page 320 triggers the “Override” page 310.

FIG. 3-B illustrates a modeless popup navigation relationship 330 that involves an original view (e.g., “ConfigThermostat” page) 350 and a popup target view (e.g., “Wiring” page) 340. The original view (e.g., “ConfigThermostat” page) 350 contains a trigger 352 for the “Wiring” page 340. Once the trigger 352 is triggered, the “Wiring” page 340 is created. Unlike the modal popup navigation relationship described in FIG. 3-A, however, both the popup target view (e.g., “Wiring” page) 340 and the original view (e.g., “ConfigThermostat” page) 350 are enabled for further interaction. Such a modeless popup navigation relationship is represented using, for example, a dotted line with an arrow at one end thereof 354. The right headed direction of the arrow indicates that the “ConfigThermostat” page 350 triggers the “Wiring” page 340. For both the modal and modeless popup navigation relationships, the semantic of the relationship is create a new view host as a target host view and put a target view to the newly created view host.

FIG. 3-C illustrates a “link” navigation relationship 360 that involves a view host (e.g., “Login” page) 380 and a target view (e.g., “Forget Password” page) 370. The view host (e.g., “Login” page) 380 contains a trigger (e.g., “Enter user name and password” widget) 382 for the “Forget Password” page 370. The semantic of the link navigation is use the view host (e.g., the “Login” page) 380 as a target view host and put the target view (e.g., the “Forget Password” page) 370 to the view host (e.g., the “Login” page) 380. Such a link navigation relationship 360 is represented using, for example, a solid line with a dark triangle at one end thereof 384. It is noted that there is another link navigation relationship 374 in FIG. 3-C with an opposite direction. The link navigation relationship 374 indicates that the “Login” page 380 is restored into the “Forget Password” page 370 when a trigger 372 associated with the “Login” page is triggered in the “Forget Password” page 370. That is, the link relationship is replacement navigation.

FIG. 3-D illustrates a “host” navigation relationship 390 that involves a current view of “SetupUser” page 392 and target views of “UserProperty,” “AssignStatToUser” and “AssignPrivileges” pages 398-1, 398-2, 398-3. The current view of the “SetupUser” page 392 contains a view host widget 394 as explained in FIG. 1-B. In some embodiments, the current view 392 has another widget 396. This widget 396 is distinguished from the view host widget 394 in that the widget 396 does not host a target view. In some embodiments, the widget 396 is a “user list” and the view host widget 394 just contains the views for the selected user. In any case, the view host widget 394 contains tab navigators (not shown in FIG. 3-D) for each of the three target views 398-1, 398-2, 398-3. For example, once the tab navigator corresponding to the “UserProperty” page 398-1 is selected, the view of the “UserProperty” page 398-1 is put into the view host widget 394 because the view host widget 394 is identified as a target view host under the host navigation relationship. Likewise, each of the other target views 398-2, 398-3 is put into the view host widget 394 upon triggering of a corresponding tab navigator. In this example, it is noted that the widget 396 still remains in the current view of the “SetupUser” page 392. In another example, the current view has the view host widget 394 only. In such a scenario, when any of the tab navigators is selected, the view of the corresponding page is put into the entire view of the “SetupUser” page 392. Logically, in any event, each target view 398-1, 398-2, 398-3 is embedded in the current view 392 by the host navigation. It is also noted that the “UserProperty” page 398-1 is distinguished from other target views 398-2, 398-3 because it is the target view that is currently triggered by the “SetupUser” page 392.

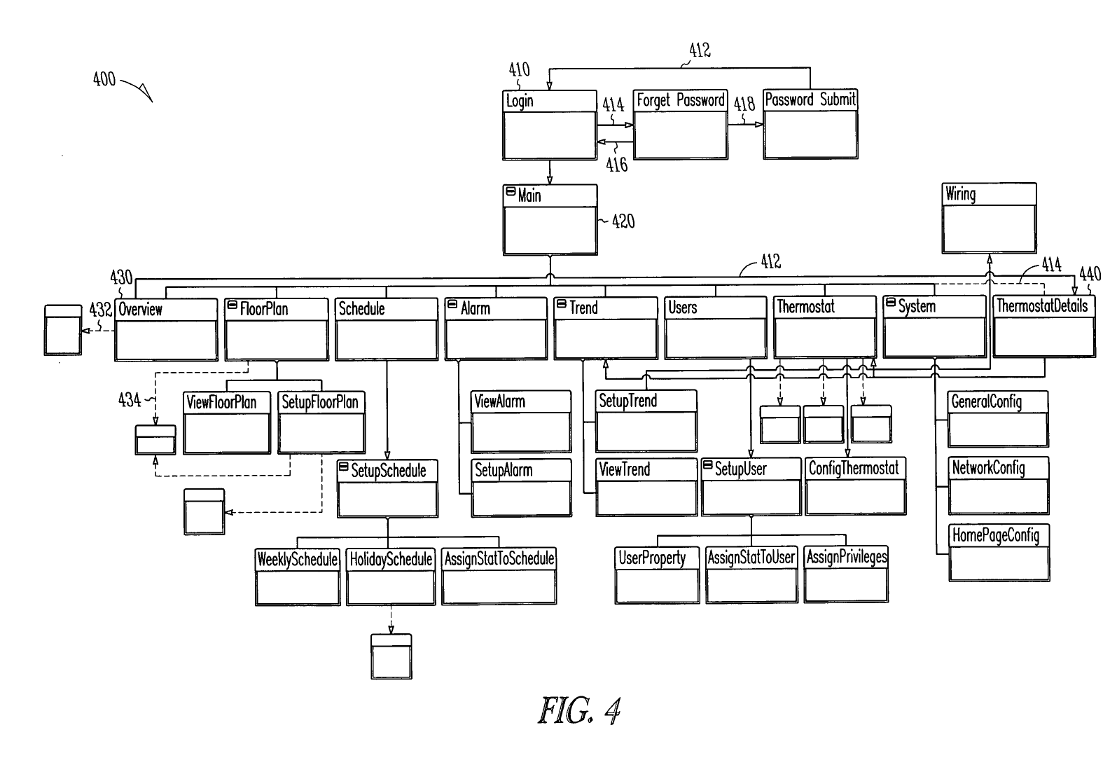

FIG. 4 illustrates a navigation diagram 400 in accordance with some embodiments of the present invention. A user interface project has only one navigation diagram 400. The navigation diagram 400 has only one “entry page” 410. The entry page 410 is distinguished from other pages using one or more of different representations, such as coloring or highlighting, etc. (not shown in the FIG. 4). A host navigation relationship in the navigation diagram 400 is either a direct 412 or indirect 414 relationship. The indirect host navigation relationship 414 is distinguished (e.g., in a dotted line) from the direct host navigation relationship 412 (e.g., in a solid line). For example, the page “ThermostatDetails” 440 could be hosted in the “Main” page 420 by triggering from the page “Overview” 430 as explained in FIG. 2. This direct relationship is shown in a solid line 412. From the “Main” page 420, however, there is no widget that can cause (trigger) a “host navigation” to embed the “ThermostatDetails” page 440 into the “Main” page 420. That is, the relationship between the “Main” page 420 and the “ThermostatDetails” page 440 is indirect and shown in a dotted line without any arrow 414. The navigation diagram 400 also shows other navigation relationships, such as a modal popup relationship 432, 434 and a “link” relationship 412-418, as explained in FIGS. 3-A and 3-C, respectively.

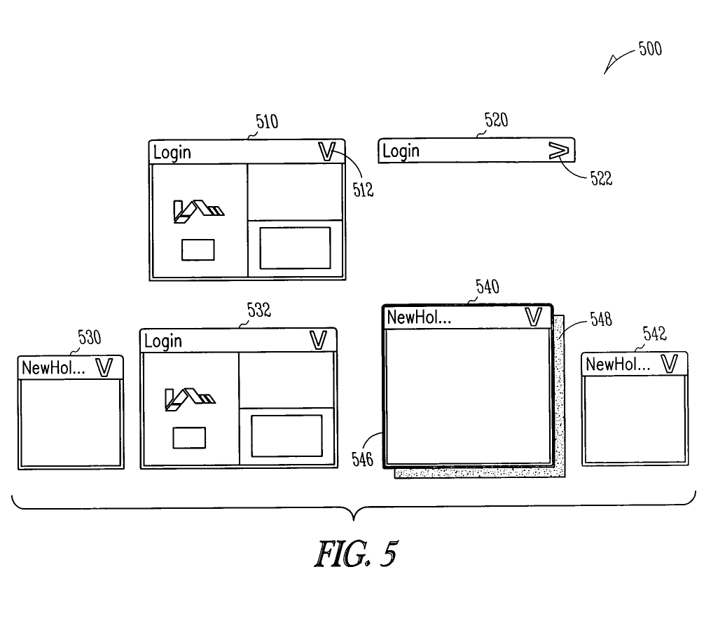

FIG. 5 illustrates several examples of representation of a page provided by some embodiments of the present invention. Initially, a page represented in an expanded form 510. When a trigger (e.g., ‘V’ mark) 512 is triggered, the expanded page is transformed into a “collapsed” form 520. The trigger (e.g., the ‘V’ mark) 512 is also changed to a ‘>’ mark 522 indicating that the collapsed page 520 can be expanded again upon clicking the ‘>’ mark. One of the two viewing modes (e.g., “collapsed” view and “expanded” view) can be chosen either individually for each page or collectively for a group of selected pages. The size of the page of a target view 530 is proportionally adjusted according to the page's relationship with a triggering page 532. A selected page 540 is distinguished from a non-selected page 542 using, for example, a bold line 546, shading 548, different coloring (not shown in FIG. 5) or the combination of two or more of them.

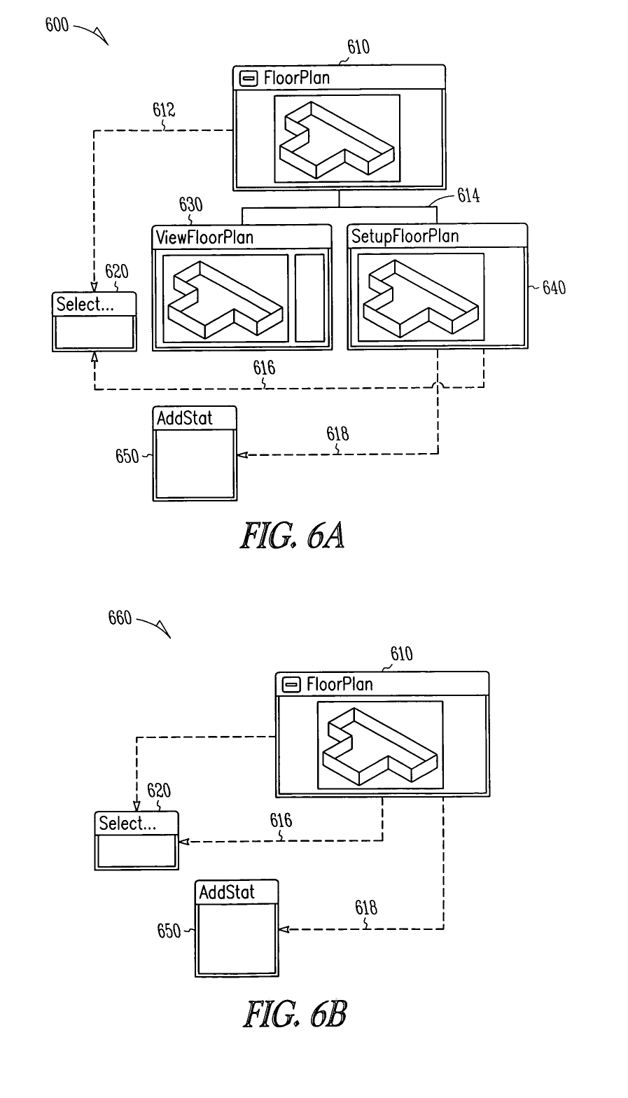

FIGS. 6-A and 6-B illustrate a part of a navigation diagram of an expanded view 600 and collapsed view 660 of a given page (e.g., “FloorPlan” page 610) provided by some embodiments of the present invention. Referring to FIG. 6-A, when an expanded view 600 is chosen for a current view (e.g., the “FloorPlan” page) 610, both a direct host navigation relationship 614 and indirect host navigation relationships 616, 618 are represented in a navigation diagram along with their corresponding pages. That is, pages 630, 640 are represented as being in the direct relationship 614 with the “FloorPlan” page 610. Pages 620 and 650 are represented as being in the indirect relationships 616 and 618, respectively. Referring to FIG. 6-B, when the “FloorPlan” is collapsed, the direct host navigation relationship 614 and its corresponding pages 630, 640 are disappeared from the expanded view 600. The indirect host navigation relationship 616, 618 and their corresponding pages 620, 650, however, still remain in the collapsed view 660. In FIGS. 6-A and 6-B, it is noted that the navigation relationship 612 is a modal popup navigation relationship as explained in FIG. 3-A and that the relationship 612 also remains in the collapsed view 660. To distinguish from the primary representation of the modal popup navigation relationship 612, the indirect host navigation relationships 616, 618 are rendered in a secondary representation, such as a lighter-shaded dotted line with a lighter-colored triangle at one end thereof.

In some embodiments of the present invention, a front end interface is provided in a UI design system. A user (e.g., a UI designer) can interact with the UI design system through the front end interface. The front end interface provides, for example, following page operations for the user to manipulate pages:
Select a Page: Select a Page to do more specific operations;
Add a Page: Create a Page file in the UI Project;
Delete a Page: Remove the Page file in the UI Project;
Open a Page: Switch to the Page Editing Diagram;
Create a Navigation relationship between two pages: Create the Navigation Binding to the Trigger widget; and
Remove Navigation relationships.

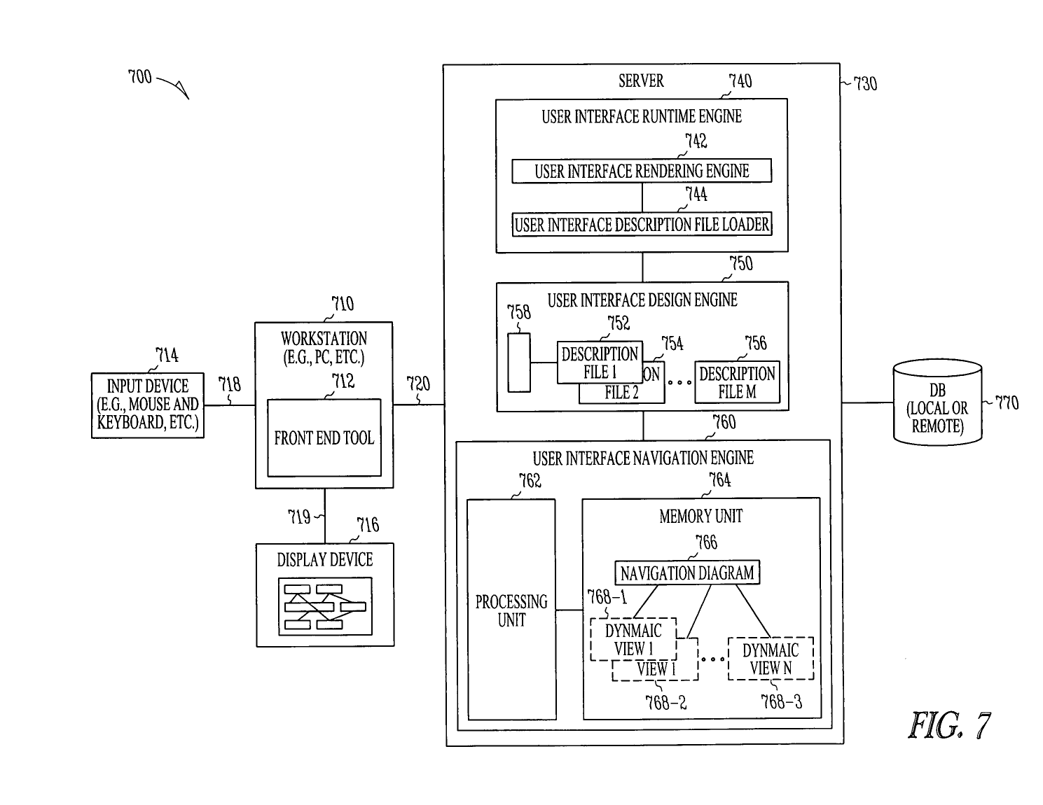

FIG. 7 schematically shows a system environment for designing a graphical user interface (UI) in which some embodiments of the present invention can be used. The UI designing system 700 includes a workstation (e.g., personal computer, etc.) 710 and a server 730. The workstation has a front end tool 712, input device 714 and display device 716. The front end tool 712 receives 718 user requests from an end user (e.g., a UI designer) (not shown in FIG. 7) through he input device 714 (e.g., one or more of a mouse, keyboard and electronic pen, etc.) and transfers 718 the user requests to the server 730. Later, when the server 730 processes the user requests and sends back responses to the user requests to the workstation 710, the front end tool 712 provides 719 the responses through the display device 716. The workstation 710 is connected 720 to the server 730 locally, or remotely using a suitable network, such as the Internet, LAN or WAN, etc.

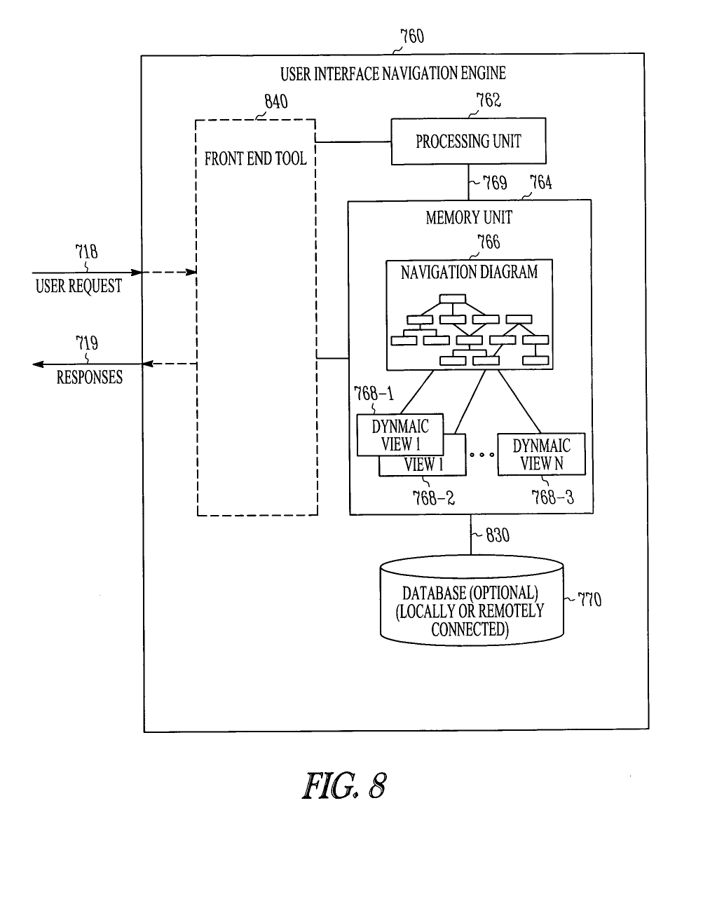

The server 730 comprises UI Design Engine 750 and UI Navigation Engine 760. The UI navigation engine 760 comprises a processing unit 762 and memory unit 764. In some embodiments, the processing unit 762 creates a navigation diagram 766 and one or more dynamic views 768-1, 768-2, 768-3 of the navigation diagram 766, and stores them into the memory unit 764 which is operatively couple to the processing unit 762. More detailed explanation about the navigation engine is given below using FIG. 8.

The UI design engine 750 uses the navigation diagram 766 and/or dynamic views 768 and creates one or more user interface description files 752, 754, 756. A user interface description file includes specification for navigation structure in a given graphical user interface. For this purpose, the UI design engine 750 either has a dedicated processing unit (not shown in FIG. 7) or shares the processing unit 762 with the UI navigation engine 760. In some embodiment, the UI design engine 750 includes Model Synchronizer Engine 758 to synchronize one or more changes occurring in a given UI designing project. In some embodiments, navigation specification information exists in the configuration of some widgets in the related pages. In such scenarios, it is not necessary to store the information into a separate place—just put the information in the user interface description file. The UI description file is the main artifact processed by UI form/page editor. That is, UI designers (the end users) could modify the navigation information in the UI editor. At some times, the UI designers could also modify the navigation structure in a dedicated UI navigation editor in a more intuitive way. At the same time, the end users could rename or reorganize the UI description files. These activities would break navigation links. The model synchronizer engine 758 synchronizes such modifications in the navigation model.

In some embodiment, the UI navigation engine 760 and the UI design engine are combined into a single entity (not shown in FIG. 7). In any case, the UI design results, such as the UI description files, are platform independent. In some examples, the files might be transformed to concrete UI platform formats (such as some XML-based UI files) or platform-specific programming language source code at design time. In other examples, the UI description file is reused directly at runtime. In such scenarios, a user interface runtime engine is needed at UI runtime to execute the navigation specification in the UI description files.

In some embodiments, therefore, the server 730 further comprises UI Runtime Engine 740. The UI runtime engine 740 executes navigation of the graphical UI using the UI description files 752, 754, 756 stored in the UI design engine 750. In some embodiments, the UI runtime engine 740 includes UI interface Rendering Engine 742 and UI Description File Loader 744. The user interface description file loader 744 loads one or more of the UI description files (752, 754, 756) generated by the UI design engine 750 to a memory unit associated with the UI runtime engine 740. The user interface rendering engine 742 then displays screen views and navigation relationships among the screen views according to navigation specifications extracted from the loaded UI description files. For this purpose, the UI runtime engine 740 either has a dedicated processing unit (not shown in FIG. 7) or shares the processing unit 762 with the UI navigation engine 760. It is noted that the server 730 can be implemented using various embodiments. For example, although FIG. 7 shows that all of the UI design engine 750, UI navigation engine 760 and UI runtime engine 740 are located in the server 730, each of the engines can be located in a separate machine (not shown in FIG. 7). It is also noted that the server 730 can have a database 770 separate from the server's internal memory, such as the memory unit 764. In such a scenario, each engine or database can be connected to another locally, or remotely using a suitable network, such as the Internet, LAN and WAN, etc. (not shown in FIG. 7).

FIG. 8 shows detailed schematic illustration of the UI navigation engine 760 in accordance with some embodiments of the present invention. The UI navigation engine 760 comprises a processing unit 762 and memory unit 764. The UI navigation engine 760 receives user requests 718, processes the user requests and returns responses 719 via the front end tool 710 shared by other engines as explained in FIG. 7. In some embodiments, however, the UI navigation engine can have a dedicated front end tool 840. The dedicated front end tool can be locally located in the same machine (e.g., the server 730) as the UI navigation engine 760 or remotely located in a separate machine (e.g., the workstation 710).

In processing the user requests 718, the UI navigation engine 760 models each UI navigation relationship in a given graphical user interface project using a tuple having multiple attributes. In some embodiments, the tuple is represented by a tuple having trigger, target view and target view host as explained above using FIGS. 1-6. In another embodiment, the tuple is refined by dividing the trigger into a navigation widget and navigation event. In any of these scenarios, the target view can be either a normal page or a template page. The navigation relationships include not only hyperlinked relationships but also non-hyperlinked relationships. The non-hyperlinked relationships includes widget-based relationships, such as modal or modeless popup navigation relationships, host navigation relationships as described using FIGS. 3-A through 3-D.

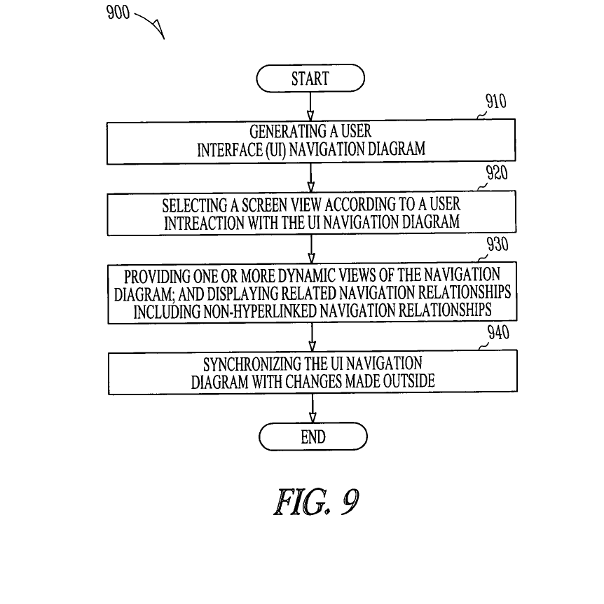

Once some or all of the navigation relationships in the UI project are represented using tuples, the UI navigation engine 760 displays the hyperlinked and non-hyperlinked navigation relationships. As a result of the displaying process, the processing unit 762 creates a navigation diagram 766 and one or more dynamic views 768-1, 768-2, 768-3 of the navigation diagram 766, and stores them into the memory unit 764 which is operatively couple to the processing unit 762. In some embodiments, the UI navigation engine 760 further includes a database operatively connected to the memory unit 764. The connection can be either local or remote. In this scenario, the navigation diagram 766 and dynamic views 768 can be stored to and referenced from the database as necessary for processing the user requests. More detailed explanation about the rendering process is given below using FIGS. 9-12.

FIG. 9 illustrates a flow chart 900 of a method for designing a graphical user interface (GUI) in accordance with some embodiments of the present invention. At step 910, a user interface navigation diagram is generated. The user interface diagram displays some or all of a plurality of screen views and corresponding navigation relationships for a given graphical user interface. In some embodiments, each navigation relationship is represented using a tuple comprising a trigger, target view and target view host. In some embodiments, the trigger is divided into a navigation widget and navigation event. The navigation relationship is either a hyperlinked or non-hyperlinked navigation relationship. In some embodiments, the non-hyperlinked relationships are widget-based relationships, such as modal or modeless popup navigation relationships, host navigation relationships as described using FIGS. 3-A through 3-D. At step 920, a screen view is selected according to a user interaction with the UI navigation diagram. At step 930, one or more dynamic views of the UI navigation diagram are provided as a function of the selected screen view. In providing the dynamic views, the navigation relationships and screen views associated with the selected screen view are distinguished from other navigation relationships and screen views using a different representation (e.g., coloring, shading, etc.). The distinguished representation provides an enhanced navigation diagram such that it enables a user to recognize related pages and navigation relationships more easily and quickly. At step 940, the user interface navigation diagram is optionally synchronized with changes made in the GUI. The changes in the GUI includes, for example, screen view creation, screen view removal, screen view renaming, screen view path change, navigation creation, navigation removal and change in navigation definition, etc.

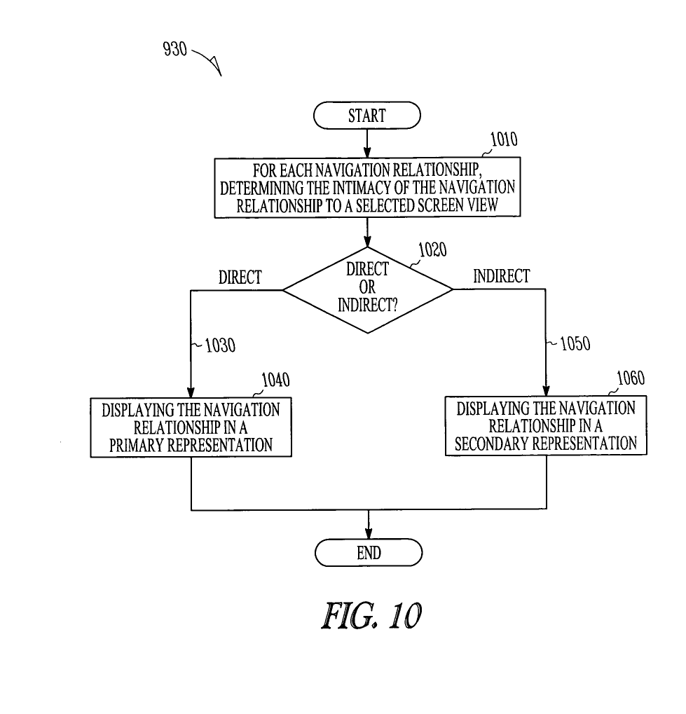

FIG. 10 is a detailed flow chart for the step 950 above in accordance with some embodiments of the present invention. At step 1010, for each of the navigation relationships associated with a selected screen view, the intimacy of the navigation relationship to the selected screen view is determined. At step 1020, the identified intimacy of the navigation relationship is questioned. If the navigation relationship turns out to be ‘direct’ 1030, the control goes to step 1040. At step 1040, the navigation relationship is rendered in a primary representation. If the navigation relationship turns out to be ‘indirect’ 1050, the control goes to step 1060. At step 1060, the navigation relationship is rendered in a secondary representation. In some embodiments, a dotted line is used to represent an indirect navigation relationship.

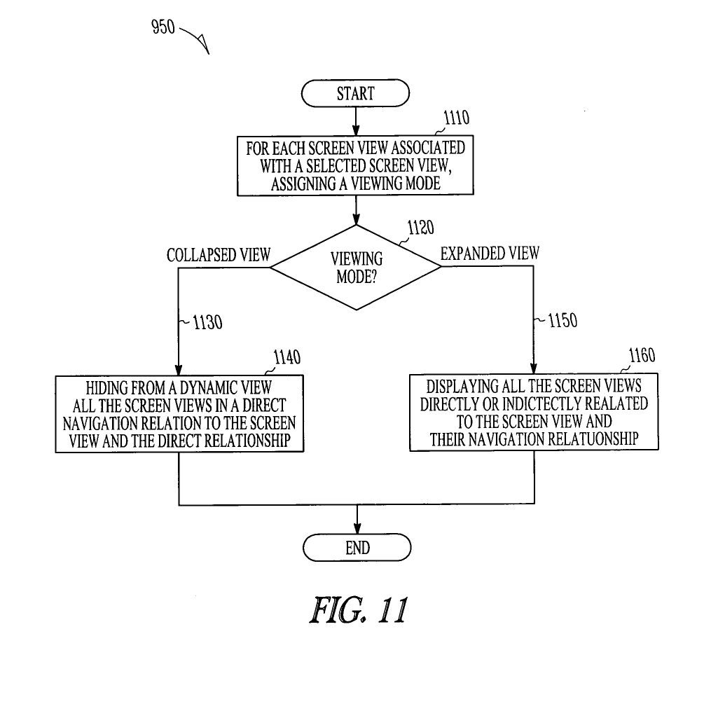

FIG. 11 is a detailed flow chart for the step 950 above in accordance with some embodiments of the present invention. At step 1110, for each of the screen views associated with a selected screen view, a viewing mode is assigned. At step 1120, the assigned viewing mode is determined. If the viewing mode is determined to be a collapsed view 1130, the control goes to step 1140. At step 1140, all the screen views in a direct navigation relationship with the selected screen view and the direct navigation relationship is hidden from a dynamic view corresponding to the selected screen view. If the viewing mode is determined to be an expanded view 1150, the control goes to step 1160. At step 1160, all the screen views directly or indirectly related to the selected screen view are displayed along with their corresponding navigation relationships.

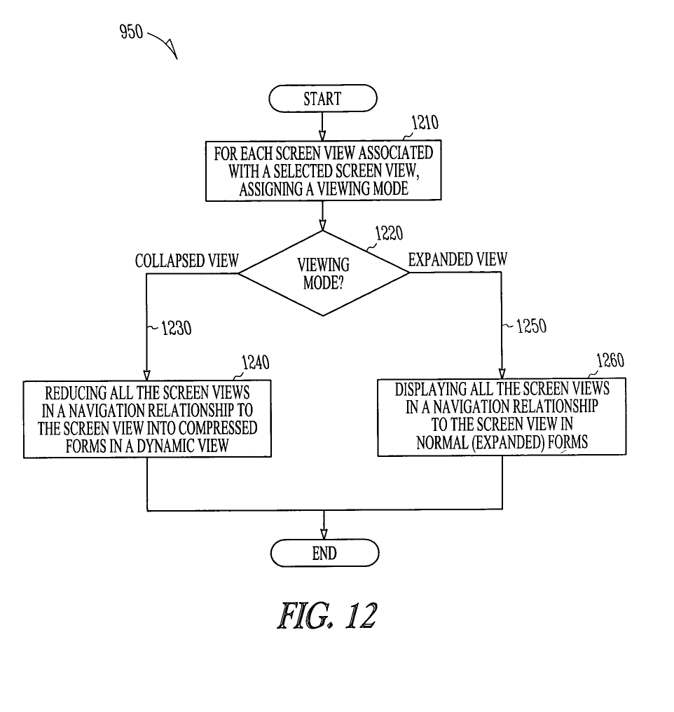

FIG. 12 is a detailed flow chart for the step 950 above in accordance with some embodiments of the present invention. At step 1210, for each of the screen views associated with a selected screen view, a viewing mode is assigned. At step 1220, the assigned viewing mode is determined. If the viewing mode is determined to be a collapsed view 1230, the control goes to step 1240. At step 1240, all the screen views in a navigation relationship with the screen view are reduced into compressed forms in a dynamic view corresponding to the selected screen view. If the viewing mode is determined to be an expanded view 1250, the control goes to step 1260. At step 1260, all the screen views in a navigation relationship with the selected screen view are displayed in normal (e.g., expanded) forms.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media such as during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The conceptual model in some embodiments of the present invention provides a navigation diagram representing not only a hypertext-based relationship but also non hypertext-based relationships. As a result, some embodiments of the present invention allow dynamically rendering more comprehensive relationships among views (e.g., pages) according to an end user (e.g., user interface designer, etc)'s interaction with the navigation diagram. Some embodiments of the present invention allow designing a user interface navigation structure using the navigation diagram. In particular, some embodiments of the present invention allow presenting all user interface pages of a user interface project in a navigation diagram. Some embodiments of the present invention also allow visualizing all relationships among the pages. Furthermore, some embodiments of the present invention allow synchronizing the design results with the related user interface pages. These help a user interface designer open a specific user interface page conveniently and thereby provide an efficient tool to design a user interface navigation structure easily.

### Additional Notes

The above Description of Example Embodiments includes references to the accompanying drawings, which form a part of the Description of Example Embodiments. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Description of Example Embodiments, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Description of Example Embodiments, with each claim standing on its own as a separate embodiment. The scope of the invention should be determined with reference to the appended claims, along with the full scope of equivalents to which such claims are entitled.

What is claimed is:

1. A method for designing a navigation structure for a graphical user interface having a plurality of screen views and navigation relationships among the screen views, comprising:
generating a user interface navigation diagram displaying two or more of the plurality of screen views and corresponding navigation relationships;
selecting a screen view according to a user interaction with the user interface navigation diagram; and
providing a dynamic view of the user interface navigation diagram as a function of the selected screen view, wherein providing includes displaying one or more navigation relationships including non-hyperlinked navigation relationships associated with the selected screen view.

2. The method of claim 1, wherein the non-hyperlinked navigation relationships include one or more widget navigation relationships.

3. The method of claim 1, wherein generating a user interface navigation diagram displaying two or more of the plurality of screen views and corresponding navigation relationships includes representing each navigation relationship using a tuple, the tuple comprising a trigger, a target view and a target view host.

4. The method of claim 1, wherein generating a user interface navigation diagram displaying two or more of the plurality of screen views and corresponding navigation relationships includes representing each navigation relationship using a tuple, the tuple comprising a navigation widget, a navigation event, a target view and a target view host.

5. The method of claim 1, wherein displaying one or more navigation relationships including non-hyperlinked navigation relationships associated with the selected screen view includes:
determining, for each of the navigation relationships associated with the selected screen view, if the navigation relationship is direct or indirect to the selected screen view;
if the navigation relationship is determined as direct, displaying the navigation relationship in a primary representation; and
if the navigation relationship is determined as indirect, displaying the navigation relationship in a secondary representation.

6. The method of claim 1, wherein displaying one or more navigation relationships including non-hyperlinked navigation relationships associated with the selected screen view includes:
assigning a viewing mode for each of the screen views associated with the selected screen view;
determining the assigned viewing mode; and
if the viewing mode is determined to be a collapsed view, hiding from the dynamic view entire screen views in a direct navigation relationship with the screen view and the direct navigation relationship.

7. The method of claim 1, wherein displaying one or more navigation relationships including non-hyperlinked navigation relationships associated with the selected screen view includes:
assigning a viewing mode for each of the screen views associated with the selected screen view;
determining the assigned viewing mode; and
if the viewing mode is determined to be a collapsed view, reducing entire screen views into compressed forms in the dynamic view in a direct navigation relationship with the screen view.

8. The method of claim 1, further comprising synchronizing the user interface navigation diagram with a change introduced through the graphical user interface, the changes including at least one of a screen view creation, a screen view removal, a screen view renaming, a screen view path change, a navigation creation, a navigation removal and a change in navigation definition.

9. The method of claim 3, wherein the target view is a template page.

10. A device for designing a navigation structure for a graphical user interface having a plurality of screen views and navigation relationships among the screen views, comprising:
memory; and
a processor operatively coupled with the memory, wherein the processor is configured to:
generate a user interface navigation diagram displaying two or more of the plurality of screen views and corresponding navigation relationships;
select a screen view according to a user interaction with the user interface navigation diagram; and
provide a dynamic view of the user interface navigation diagram as a function of the selected screen view, wherein the provision includes displaying one or more navigation relationships including non-hyperlinked navigation relationships associated with the selected screen view.

11. The device of claim 10, wherein the non-hyperlinked navigation relationships include one or more widget navigation relationships.

12. The device of claim 10, wherein the processor, in generating a user interface navigation diagram displaying two or more of the plurality of screen views and corresponding navigation relationships, is to represent each navigation relationship using a tuple, the tuple comprising a trigger, a target view and a target view host.

13. The device of claim 10, wherein the processor, in generating a user interface navigation diagram displaying two or more of the plurality of screen views and corresponding navigation relationships, is to represent each navigation relationship using a tuple, the tuple comprising a navigation widget, a navigation event, a target view and a target view host.

14. The device of claim 10, wherein the processor, in displaying one or more navigation relationships including non-hyperlinked navigation relationships associated with the selected screen view, is configured to:
determine, for each of the navigation relationships associated with the selected screen view, whether the navigation relationship is direct or indirect to the selected screen view;
if the navigation relationship is determined as direct, display the navigation relationship in a primary representation; and
if the navigation relationship is determined as indirect, display the navigation relationship in a secondary representation.

15. The device of claim 10, wherein the processor, in displaying one or more navigation relationships including non-hyperlinked navigation relationships associated with the selected screen view, is configured to:
assign a viewing mode for each of the screen views associated with the selected screen view;
determine the assigned viewing mode; and
if the viewing mode is determined to be a collapsed view, hide entire screen views in a direct navigation relationship with the screen view and the direct navigation relationship from the dynamic view.

16. The device of claim 10, wherein the processor, in displaying one or more navigation relationships including non-hyperlinked navigation relationships associated with the selected screen view, is configured to:
assign a viewing mode for each of the screen views associated with the selected screen view;
determine the assigned viewing mode; and
if the viewing mode is determined to be a collapsed view, reduce entire screen views in a direct navigation relationship with the screen view into compressed forms in the dynamic view.

17. The device of claim 10, further comprising a front end tool operatively coupled to the processor, wherein the front end tool is configured to receive one or more page operations including an operation to bind a navigation relationship of a page to a trigger widget triggering the page.

18. A system for designing a navigation structure for a graphical user interface having a plurality of screen views and navigation relationships among the screen views, comprising:
a user interface design engine; and
a user interface navigation engine operatively coupled with the user interface design engine, wherein the user interface navigation engine includes:
memory; and
a processor operatively coupled with the memory, wherein the processor is configured to:
generate a user interface navigation diagram displaying two or more of the plurality of screen views and corresponding navigation relationships;
select a screen view according to a user interaction with the user interface navigation diagram; and
provide a dynamic view of the user interface navigation diagram as a function of the selected screen view, wherein the provision includes displaying one or more navigation relationships including non-hyperlinked navigation relationships associated with the selected screen view; and wherein the dynamic view of the user interface navigation diagram is accessed by the user interface design engine to create one or more user interface description files for the graphical user interface.

19. The system of claim 18, wherein the non-hyperlinked relationships include one or more widget navigation relationships.

20. The system of claim 18, further comprising a user interface runtime engine operatively coupled with the user interface design engine, wherein the one or more user interface description files are accessed by the user interface runtime engine to execute navigation of the graphical user interface.
